(19) United States
(12) Patent Application Publication
(10) Pub. No.: US 2018/0098102 A1
(43) Pub. Date: Apr. 5, 2018

(54) LIMITED USE MEDIA ACCESS TOKENS

(71) Applicant: INTERNATIONAL BUSINESS MACHINES CORPORATION, Armonk, NY (US)

(72) Inventors: DEMETRICE L. BROWDER, ROUND ROCK, TX (US); DOUGLAS J. GRIFFITH, BURNET, TX (US); PAVITHRA RAJAMANI, ROUND ROCK, TX (US); ISAC RODRIGUES DA SILVA, LEANDER, TX (US)

(21) Appl. No.: 15/284,788

(22) Filed: Oct. 4, 2016

(51) Int. Cl. H04N 21/239; H04L 29/06; H04N 21/258; H04N 21/254; H04N 21/6334

(52) U.S. Cl. CPC H04N 21/2396; H04L 63/10; H04N 21/63345; H04N 21/25875; H04N 21/2541; H04L 63/108

(57) ABSTRACT

Embodiments include method, systems and computer program products for managing access to media content. Aspects include receiving, by a media service provider from a subscriber, a request for a limited access to one or more media content items and creating, by the media service provider in response to the request, a token that grants the limited access to the one or more media content items. Aspects also include receiving, by the media service provider, the token from a non-subscriber and providing, by the media service provider, the limited access to the one or more media content items to the non-subscriber.

### BACKGROUND

The present disclosure relates to managing access to media content and, more specifically, to methods and systems for providing tokens that permit limited access to media content.

Streaming media services such as NETFLIX®, HBOGO®, and the like have been growing in popularity. These media services are subscription based and allow subscribers to access various media content items through a variety of mediums with a user identification and a password. It is common for subscribers of media services to want to share their access to the media service with friends that are not subscribers. However, in order for a subscriber of a currently available media service to allow a non-subscriber to access the media service, the subscriber must give the non-subscriber their user identification and password.

### SUMMARY

Embodiments include a computer-implemented method for managing access to media content, the method includes receiving, by a media service provider from a subscriber, a request for a limited access to one or more media content items and creating, by the media service provider in response to the request, a token that grants the limited access to the one or more media content items. The method also includes receiving, by the media service provider, the token from a non-subscriber and providing, by the media service provider, the limited access to the one or more media content items to the non-subscriber.

Embodiments include a media service provider for managing access to media content, the media service provider having a processor, the processor configured to receive, from a subscriber, a request for a limited access to one or more media content items and to create, in response to the request, a token that grants the limited access to the one or more media content items. The processor is also configured to receive the token from a non-subscriber and to provide the limited access to the one or more media content items to the non-subscriber.

Embodiments also include a computer program product managing access to media content, the computer program product including a non-transitory computer readable storage medium having computer readable program code embodied therewith. The computer readable program code including computer readable program code configured to perform a method. The method includes receiving, from a subscriber, a request for a limited access to one or more media content items and creating, in response to the request, a token that grants the limited access to the one or more media content items. The method also includes receiving the token from a non-subscriber and providing the limited access to the one or more media content items to the non-subscriber.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system managing access to media content in accordance with one or more embodiments; and

FIG. 5 illustrates a flowchart diagram of a method managing access to media content in accordance with one or more embodiments.

### DETAILED DESCRIPTION

In accordance with exemplary embodiments of the disclosure, methods, systems and computer program products for managing access to media content are provided. In exemplary embodiments, a subscriber of a media service can request an access token that the subscriber can provide to an individual that is not a subscriber of the media service, referred to herein as a non-subscriber. The access token can be used by the non-subscriber to obtain limited access to the media service. In exemplary embodiments, the request from the subscriber can specify the manner of access that the will provide. For example, the request can allow the non-subscriber to access only specific content items and/or it can limit the duration that the non-subscriber can access the media service.

In exemplary embodiments, subscribers can share limited access to media streaming services with non-subscribers by requesting limited access tokens that can be shared with the non-subscribers. The media streaming services can include video streaming services, audio streaming services, video game service, or the like. In one embodiment, the limited access that is shared can include the right to watch or listen to one or more specific content items, i.e., shows, songs, or games, for a pre-determined amount of time. In another embodiment, the limited access that is shared can include the right to access the media streaming for a pre-determined amount of time.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

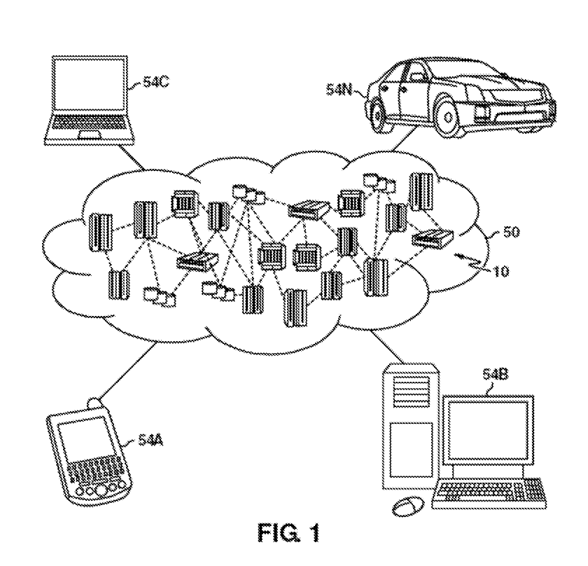

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

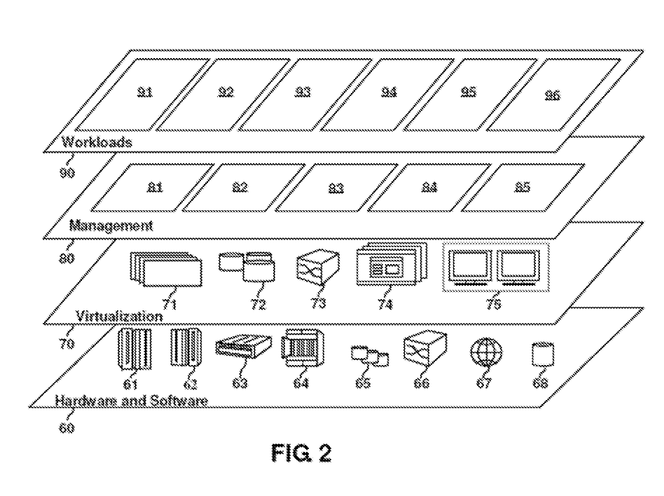

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and streaming media services 96.

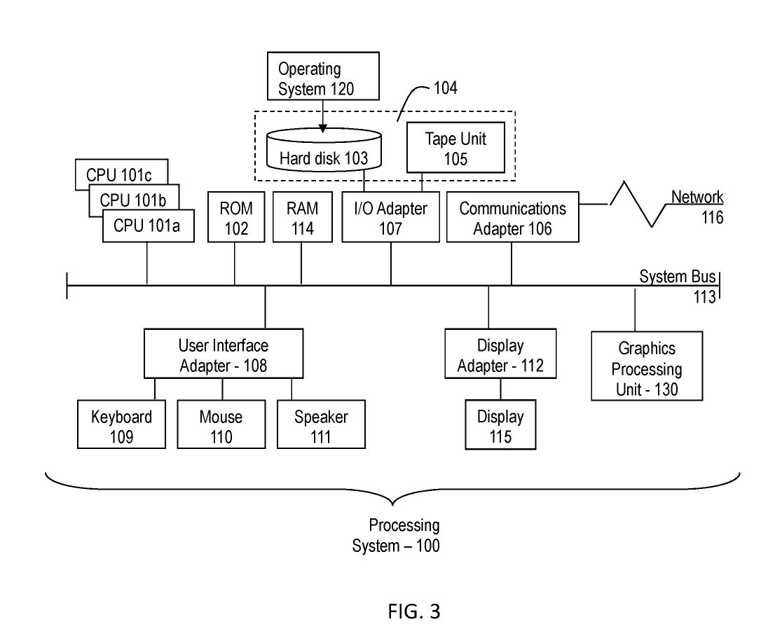

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

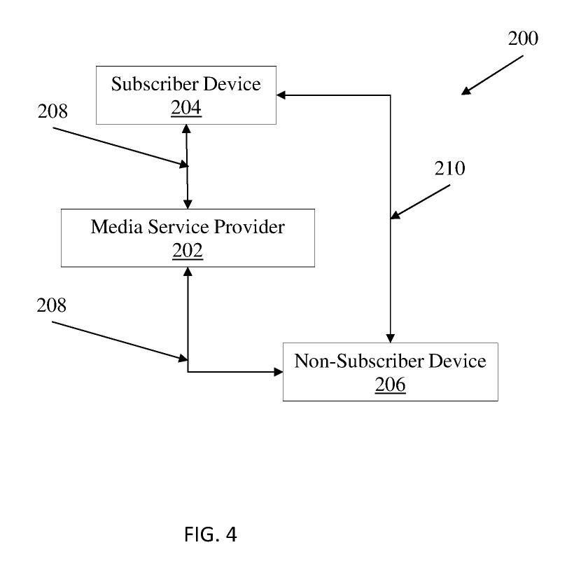

Referring now to FIG. 4 there is shown a system 200 for managing access to media content according to one or more embodiments. As illustrated, the system 200 includes a media service provider 202 that is in communication with a subscriber device 204 and a non-subscriber device 206 via communications network 208. The media service provider 202 may be embodied in a processing system similar to the one shown in FIG. 3 or it may be embodied as a cloud-based service as described with reference to FIG. 1 and FIG. 2. In exemplary embodiments, the subscriber device 204 and the non-subscriber device 206 can be smartphones, tablets, smart televisions, processing systems such as the one shown in FIG. 3, or another suitable device for receiving and playing media content items. The subscriber device 204 is configured to communicate with the non-subscriber device 206 via the communications network 210. In exemplary embodiments, the communications networks 208, 210 can include private communications networks, a public communications network3, cellular networks, the Internet, or various combinations thereof.

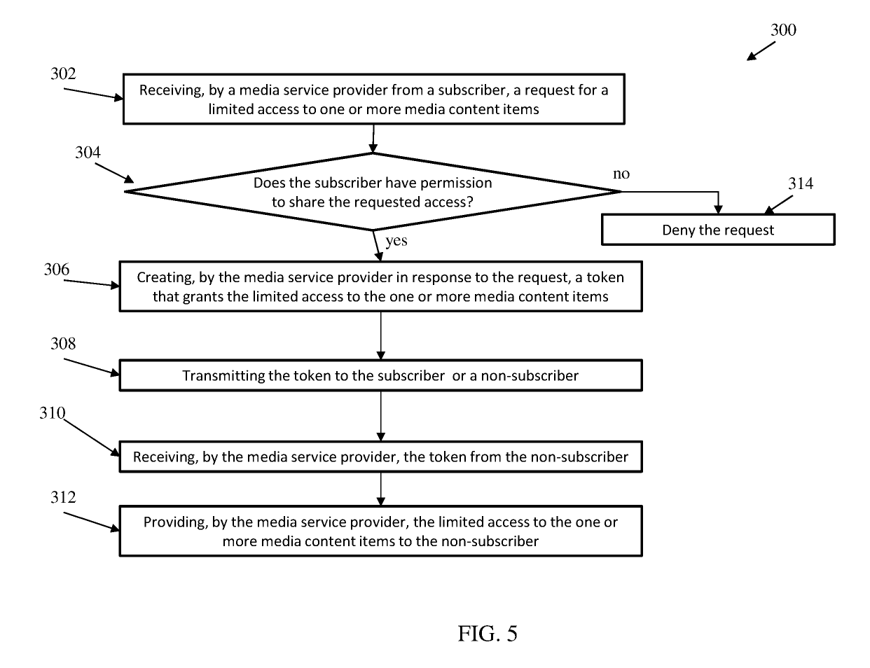

Referring now to FIG. 5 there is shown a flow diagram of a method 300 for managing access to media content according to one or more embodiments. The method 300 includes receiving, by a media service provider from a subscriber, a request for a limited access to one or more media content items. In exemplary embodiments, the request includes an identification of the one or more media content items and/or an identification of a duration of the limited access. Next, as shown at decision block 304 the method 300 includes determining if the subscriber has permission to share the requested access. In one embodiment, the determination may include determining whether the subscriber has exceeded a threshold amount of content sharing for a time period. For example, a subscriber may be allowed to share four content items a month and the determination includes determining if the subscriber has reached their limit for the month. In another embodiment, the determination may include determining whether the request content item is allowed to be shared. For example, in some content on the media service provider may not be allowed to be shared for until it has been available on the media service provider for a minimum time period. If the subscriber has permission to share the requested access, the method 300 proceeds to block 306. Otherwise, the method 300 proceeds to block 314 and denies the request.

Continuing with reference to FIG. 5, as shown at block 306, the method 300 includes creating, in response to the request, a token that grants the limited access to the one or more media content items. Next, as shown at block 308, the method 300 includes transmitting the token to the subscriber or anon-subscriber. In one embodiment, the token is transmitted to the subscriber and the subscriber shares the token with the non-subscriber. In another embodiment, the request includes an email address for the non-subscriber and the media service provider transmits the token to the non-subscriber using the email address provided in the request. In other embodiments, the request may include a cell phone number for the non-subscriber and the media service provider transmits the token to the non-subscriber via SMS message using the cell phone number provided in the request.

Next, as shown at block 310, the method 300 includes receiving, by the media service provider, the token from a non-subscriber. The method 300 also includes providing, by the media service provider, the limited access to the one or more media content items to the non-subscriber. In exemplary embodiments, the media service provider is a streaming video service provider and wherein the one or more media content items are selected from a group consisting of television shows and movies. In other embodiments, the media service provider can be a video game sharing service or an streaming audio service.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for managing access to media content, the method comprising:
receiving, by a media service provider from a subscriber, a request for a limited access to one or more media content items;
determining a number of tokens created in response to requests from the subscriber in a time period and responsive to determining that the number exceeds a threshold, denying the request;
creating, by the media service provider in response to the request, a token that grants the limited access to the one or more media content items;
receiving, by the media service provider, the token from a non-subscriber; and
providing, by the media service provider, the limited access to the one or more media content items to the non-subscriber.

2. The method of claim 1, wherein the request includes an identification of the one or more media content items.

3. The method of claim 1, wherein the request includes an identification of a duration of the limited access.

4. The method of claim 1, further comprising transmitting, by the media service provider, the token to the subscriber.

5. The method of claim 1, wherein the request includes an email address for the non-subscriber and wherein the method further comprises transmitting, by the media service provider, the token to the non-subscriber using the email address.

6. The method of claim 1, where the media service provider is a streaming video service provider and wherein the one or more media content items are selected from a group consisting of television shows and movies.

7. (canceled)

8. A media service provider for managing access to media content, the media service provider comprising:
a processor coupled to a memory, the processor configured to:
receive, from a subscriber, a request for a limited access to one or more media content items;
determine a number of tokens created in response to requests from the subscriber in a time period and responsive to a determination that the number exceeds a threshold, deny the request;
create in response to the request, a token that grants the limited access to the one or more media content items;
receive the token from a non-subscriber, and
provide the limited access to the one or more media content items to the non-subscriber.

9. The media service provider of claim 8, wherein the request includes an identification of the one or more media content items.

10. The media service provider of claim 8, wherein the request includes an identification of a duration of the limited access.

11. The media service provider of claim 8, wherein the processor is further configured to transmit the token to the subscriber.

12. The media service provider of claim 8, wherein the request includes an email address for the non-subscriber and wherein the processor is further configured to transmit the token to the non-subscriber using the email address.

13. The media service provider of claim 8, where the media service provider is a streaming video service provider and wherein the one or more media content items are selected from a group consisting of television shows and movies.

14. (canceled)

15. A computer program product for managing access to media content, the computer program product including a non-transitory computer readable storage medium having computer readable program code embodied therewith, the computer readable program code including computer readable program code configured to perform a method, the method comprising:
receiving, from a subscriber, a request for a limited access to one or more media content items;
determining a number of tokens created in response to requests from the subscriber in a time period and responsive to determining that the number exceeds a threshold, denying the request;
creating, in response to the request, a token that grants the limited access to the one or more media content items;
receiving the token from a non-subscriber, and
providing the limited access to the one or more media content items to the non-subscriber.

16. The computer program product of claim 15, wherein the request includes an identification of the one or more media content items.

17. The computer program product of claim 15, wherein the request includes an identification of a duration of the limited access.

18. The computer program product of claim 15, wherein the method further comprises transmitting the token to the subscriber.

19. The computer program product of claim 15, wherein the request includes an email address for the non-subscriber and wherein the method further comprises transmitting the token to the non-subscriber using the email address.

20. (canceled)
